(19) United States
(12) Patent Application Publication
(10) Pub. No.: US 2008/0259401 A1
(43) Pub. Date: Oct. 23, 2008

(54) Method and system for consistent color control

(75) Inventors: Michael E. Farrell, Ontario, NY (US); Javier A. Morales, Rochester, NY (US); William Samuel Jacobs, Los Angeles, CA (US)

Correspondence Address: ORTIZ & LOPEZ, PLLC, P. O. BOX 4484, ALBUQUERQUE, NM, 87196-4484, US

(73) Assignee: Xerox Corporation

(21) Appl. No.: 11/789,360

(22) Filed: Apr. 23, 2007

(51) Int. Cl. G06K 15/00

(52) U.S. Cl. 358/2.1

(57) ABSTRACT

A method and system for achieving consistent color control by integrating multiple color management and rendering techniques using single multi-level user control. Page Description Language (PDL) data and job processing instructions can be modified upstream of the Raster Image Processor (RIP). The processing operations associated with processing a print job comprising of at least one page include at least one of: flattening all objects on the at least one page into a single layer; removing overprint commands from the print job; converting all objects on the at least one page into a common colorspace; removing embedded tone reproduction curves and halftone screens from the print job.

### TECHNICAL FIELD

Embodiments are generally related to image processing methods and systems. Embodiments are also related to field of color image/text printing and display systems. Embodiments are additionally related to methods and system for improving color consistency of prints.

### BACKGROUND OF THE INVENTION

Color management is often incorrectly defined as a way to get the best-looking display and print color from all applications. Maintaining color when transferring documents and images between applications and devices (for example, monitors, printers, or scanners) is a complex process. The process is limited by the color capabilities of monitors, applications, operating systems, and printers. A color management system (CMS) can offer optimized output to printers, but it requires special equipment to calibrate the hardware and create device profiles. True color management also requires control of all color-biasing elements in the work environment (for example, paint color of the room, direct or indirect sun light), which can make color management expensive and time consuming.

Users of color printing devices experience variations in the appearance of prints produced on different devices. While some of the variation may be due to differences in the color gamut of the devices, other appearance differences result from variations in Raster Image Processor (RIP) behavior. Examples of such RIP related variations includes, differences in overprint behavior, handling of transparent objects, mapping of spot colors to process colors, and application of tone reproduction curve (TRC) and halftones that are embedded in the page description language (PDL). A raster image processor with a strong feature set and processing power can speed the process of printing complex documents, especially those with personalized variables.

One traditional solution to this problem is a RIP Once, Output Many (ROOM) workflow. This approach uses a single RIP—and RIP parameters—thereby eliminating the RIP contribution to appearance variations. This approach works well when the devices in scope behave sufficiently alike that a single RIP can produce output that prints well on all devices. Introducing printing devices that have different marking technology than offset presses or other toner based presses can stress the ROOM workflow.

Another prior solution is to approximate a ROOM workflow with multiple RIP's by attempting to converge their behavior. This approach also had limited success because some RIP behaviors lack user accessible controls (e.g. over transparent object printing). Other behaviors with controls have different semantics or responses (e.g. overprinting) and the approach is complex, leaving many users unaware of how the controls can affect print color appearance. While most color printer users are familiar with source and destination ICC profiles, their understanding of the contribution of overprint, transparent objects, rendering intents, embedded halftone screens, and specification of spot colors is generally much weaker. Further, they often do not know the relative sequence in which the controls should be applied so as to minimize side effects.

In an effort to address the foregoing shortfalls, the present inventors believe that a workflow function can be provided that allows users to maximize color consistency across printers by modifying the PDL content and job processing instructions such that all printers in scope can produce consistent results. Additionally, a single control can be linked to multiple discrete color management and RIP controls thereby hiding the complexity from the user.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for improved image processing methods and systems.

It is another aspect of the present invention to provide for improved color printing methods and display systems.

It is a further aspect of the present invention to provide methods and system for improving color consistency of prints.

The aforementioned aspects and other objectives and advantages can now be achieved as described herein. A method and system for achieving consistent color control by integrating multiple color management and rendering techniques using single multi-level user control. Page Description Language (PDL) data and print job processing instructions can be modified upstream of the Raster Image Processor (RIP). The processing operations include at least one of flattening objects on the page until they are opaque while keeping a translucent appearance, removing all overprint commands, converting all objects to a common color space and gamut and removing any embedded TRC's or halftone screens. These multiple levels can be carried out during document printing for achieving consistent color control, each level associated with a distinct set of color and rendering behaviors.

The single multi-level user control can allow unskilled users to manage the tradeoff between color consistency and maximum color gamut. The single control can be linked to multiple discrete color management and RIP controls thereby hiding the complexity from the user. An administrator, who can be the only color expert needed, can change the settings and selections behind each of the levels. The administrator can go so far as to configure the overall number of levels available to the unskilled operators.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of data-processing system, which can be utilized for improving color consistency of prints created by multiple output devices, in accordance with a preferred embodiment;

FIG. 2 illustrates an exemplary document used in the system for improving color consistency of prints created by multiple output devices, in accordance with a preferred embodiment.

FIG. 3 illustrates a high level flow chart of operations depicting logical operational steps of integrating multiple color management and rendering techniques into a single multi-level user control, in accordance with a preferred embodiment;

FIG. 4 illustrates a high level flow chart of operations depicting logical operational steps of providing multiple levels for modifying PDL content and job processing instructions, in accordance with a preferred embodiment;

### DETAILED DESCRIPTION

The particular values and configurations discussed in these non-limiting examples can be varied and are cited merely to illustrate at least one embodiment and are not intended to limit the scope thereof.

The embodiments described herein can be implemented in the context of a host operating system and one or more modules. Such modules may constitute hardware modules, such as, for example, electronic components of a computer system. Such modules may also constitute software modules. In the computer programming arts, a software “module” can be typically implemented as a collection of routines and data structures that performs particular tasks or implements a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing system (e.g., a computer system), those skilled in the art will appreciate that the mechanisms of the embodiments are capable of being distributed as a program product in a variety of forms, and that the present invention applies equally regardless of the particular type of signal-bearing media utilized to actually carry out the distribution. Examples of signal bearing media include, but are not limited to, recordable-type media such as media storage disks or CD ROMs and transmission-type media such as analogue or digital communications links.

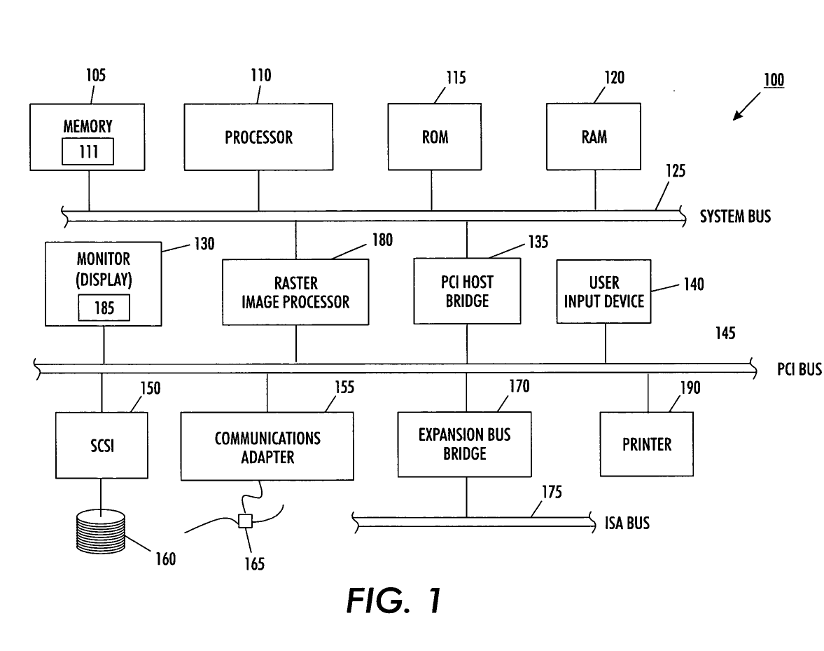

Referring to the drawings and in particular to FIG. 1, there is depicted a data-processing apparatus 100 which can be utilized to improve color consistency of prints in accordance with features of the invention and a preferred embodiment. As shown in FIG. 1, a memory 105, a processor (CPU) 110, a Read-Only memory (ROM) 115, and a Random-Access Memory (RAM) 120 are generally connected to a system bus 125 of apparatus 100. Memory 105 can be implemented as a ROM, RAM, a combination thereof, or simply a general memory unit. A Color Consistency Module 111 can be stored within memory 105 and then retrieved and processed via processor 110 to perform color consistency tasks and enable user control over color consistency in accordance with features of the invention. A user input device 140, such as a keyboard, mouse, or another pointing device, can be connected to PCI (Peripheral Component Interconnect) bus 145 to further access to and use of Color Consistency Module 111.

Data-processing system thus includes CPU 110, ROM 115, and RAM 120, printer 190 which are also coupled to Peripheral Component Interconnect (PCI) local bus 145 of data-processing apparatus 100 through PCI host-bridge 135. PCI Host Bridge 135 provides a low latency path through which processor 110 may directly access PCI devices mapped anywhere within bus memory and/or input/output (I/O) address spaces. PCI Host Bridge 135 also provides a high bandwidth path for allowing PCI devices to directly access RAM 120.

Also attachable to PCI local bus 145 are communications adapter 155, small computer system interface (SCSI) 150, raster image processor (RIP) 180 and expansion bus-bridge 170, communications adapter 155 is utilized for connecting data-processing apparatus 100 to a network 165. SCSI 150 is utilized to control high-speed SCSI disk drive 160. Expansion bus-bridge 170, such as a PCI-to-ISA bus bridge, may be utilized for coupling ISA bus 175 to PCI local bus 145. Note that PCI local bus 145 can further be connected to a monitory 130, which functions as a display (e.g., a video monitor) for displaying data and information for a user and for interactively displaying a graphical user interface (GUI) 185 wherein color consistency controls can be managed.

Note that the term “GUI” generally refers to a type of environment that represents programs, files, options and so forth by means of graphically displayed icons, menus, and dialog boxes on a computer monitor screen 130. A user can interact with the GUI 185 to select and activate color control options by pointing and clicking with a user input device 140 such as, for example, a pointing device such as a mouse, and/or with a keyboard. A particular item can function in the same manner to the user in all applications because the GUI 185 can provide access to standard software routines (e.g., module 111) to manage these elements and can report a user's actions. The graphical user interface 185 can allow modification of certain characteristics of the printed image such as lightness/darkness, contrast, highlights, shadows, and color cast. In this regard, a user can actuate the appropriate keys on the user interface 185 to adjust the parameters of a print job.

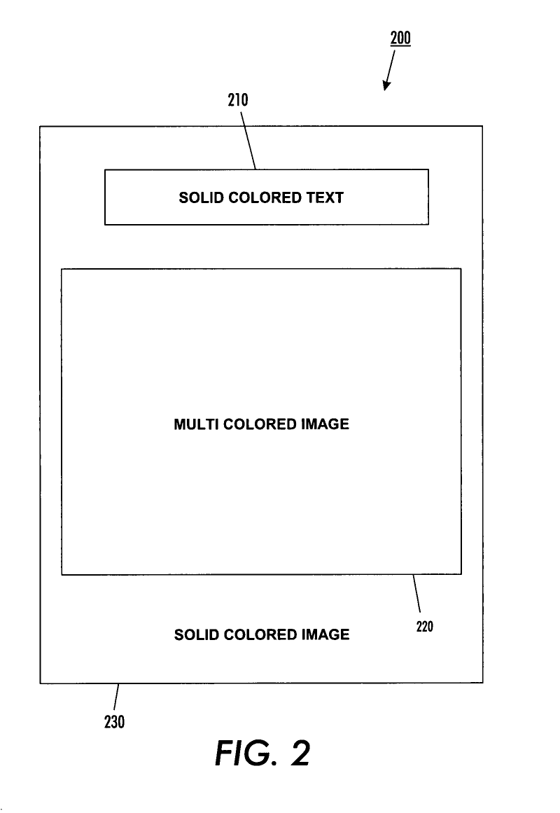

Provided as an example, an operator, such as a graphics artist, can run a composition program on the computer to create the digital document which contains objects such as color images, graphics and/or text. The operator may use scanned images, computer programs, or other generation means to create the digital document 200 as shown in FIG. 2. Typically, such generation means generates three-dimensional color signals, i.e., red, green, blue (RGB) to represent the objects; however, the generation means can also generate other combinations of colors such as cyan, magenta, yellow and black (CMYK). The digital document 200 is displayed on the monitor 130 as an array of grey scale pixel values (ranging from 0 to 255) representing the intensity of each of the plurality the colors at each pixel location. Upon receiving an instruction to print the file, the composition program and a print driver (not shown) converts the contone image or native file into any file format that can be consumed by the DFE and turned into a raster document for output, such as a page description language (PDL) document (e.g., Postcript, PDF, PPML, CIPP, LCDS, IPDS, AFP, VPS, TIFF, ST/LW, etc.).

The printer driver fills the memory 105 with a portion of the print stream. The printer driver then updates a status indicator by sending a message (in one implementation through the operating system) to a raster image processor (RIP) 180 to let RIP 180 know that data is present in the memory 105. The RIP 180 consumes the contents of the memory 105 upon receipt of the message and generates raster data which is suitably encoded for the proofing printer in an encoded raster file. The process repeats for each portion of the print stream. Alternatively, memory 111 can be sized to store the entire print stream and RIP 180 may consume all or a predetermined amount of the contents of memory 111 when the message is received.

Referring to FIG. 2 an exemplary document 200 which can be utilized for improving color consistency of prints created by multiple output devices is illustrated. The document 200 is provided for exemplary purposes and includes several objects, such as multi colored image object 220, a solid colored border object 230, and a solid colored text object 210, although the document 200 can include a greater or lesser number of objects.

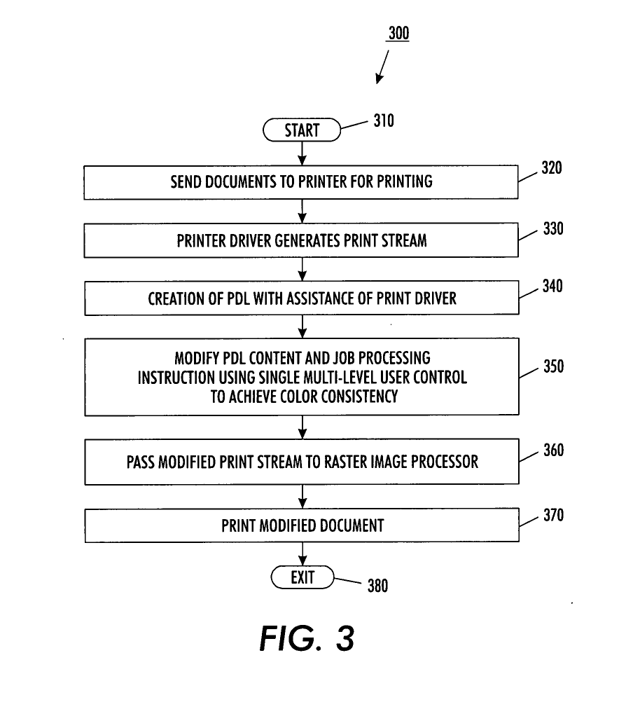

Referring to FIG. 3 a high level flow chart of operations depicting logical operational steps of integrating multiple color management and rendering techniques into a single multi-level user control 300 is illustrated in accordance with a preferred embodiment. Note that the process or method 300 described in FIG. 3 can be implemented in the context of a software module such as module 111 of apparatus 100 depicted in FIG. 1. The process depicted in FIG. 3 can be initiated, as indicated at block 310. The document 200 as shown in FIG. 2 can be sent to printer 190 for printing, as illustrated at block 320. It should be appreciated that a user can also specify print job processing remote from the system's interface at the time of the document's submission to the system over a data network. This can include the methods for insuring color consistency. A user can use the user input device 140 to send the document 200 to the printer 190. Following a printing request, the printer driver generates print stream as shown at block 330. Thereafter, PDL printer description can be created in the system with the assistance of the printer driver as depicted at block 340. The PDL content and print job processing instructions are modified using single multi-level user control to achieve color consistency, as shown at block 350. Document color consistency across multiple devices can be improved by processing the PDL data and job processing instructions upstream of the raster image processor 180 associated with the printer 190 which removes all conditions of color rendering ambiguity. The modified pint stream can be passed to the raster image processor 180, as shown at block 360. The modified document can be printed as depicted at block 370. The process can then terminate, as indicated at block 380.

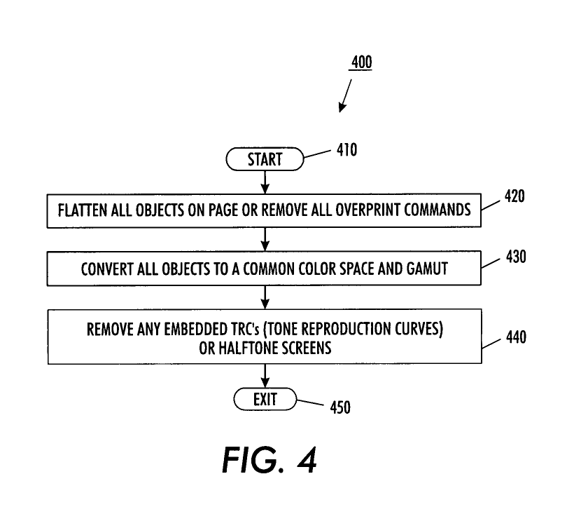

Referring to FIG. 4 a high level flow chart 400 depicting operational steps representing multiple levels that can be implemented, independently or as a group, into the printing process to achieve color consistency in documents. The process of achieving color consistency depicted in FIG. 4 can be initiated, as indicated at block 410. All objects on the page of the document 200 can be flattened on a page until they are opaque while keeping a translucent appearance, or a simpler, partially effective alternative that can be followed in to remove all overprint commands, as shown at block 420. Thereafter, all objects on the page of the document 200 can be converted to a common color space and gamut, as depicted at block 430. The colorspace can be selected from at least one of: a user specified industry standard (e.g., SWOP Coated), a user defined colorspace (e.g., a shop colorspace), and a system generated colorspace using techniques. Performing a color space transformation can require complementary modification of the job processing instructions associated with the job. For example, a job prepared for a specific printer's Device CMYK and programmed for Device CMYK color management—the pass through mode—can be converted to SWOP Coated CMYK and the job processing instructions can be revised in order to request the SWOP Coated behavior of the DFE. Preservation of spot colors is an option for users seeking to maximize spot color fidelity to an external reference such as a color swatch. The color transformation can further include differences due to substrate gloss and post-printing gloss modification such as over coating. Embedded TRC's or halftone screens can be removed, as illustrated at block 440. The resolution of embedded TRC and halftones includes ignore and specify matching halftones and TRC's in job programming instructions. The job processing instructions can be modified in order to select a halftone screen that best emulates the embedded halftone screen. The TRC can also be applied to the objects in the file. The process can then terminate, as indicated at block 450.

Based on the foregoing it can be appreciated that a system can be provided, that allows users to maximize color consistency across printer 190 by modifying the PDL content and job processing instructions such that all printers in scope can produce consistent results. A potential enhancement to the invention is to adaptively define the levels as a function of the DFE within scope of the workflow. The more diverse the RIP behavior, the more active each level would be. For example, if only the DFE of a common software release were in scope, it would be possible to avoid flattening transparent objects because all of the DFE would handle transparent objects in the same manner.

It will be appreciated that variations of the above disclosed features and functions, or alternatives thereof, can be desirably combined into many other different systems or applications. Also that various presently unforeseen or unanticipated alternatives, modifications, variations or improvements therein can be subsequently made by those skilled in the art which are also intended to be encompassed by the following claims.

What is claimed is:

1. A method for improving color consistency of prints by preprocessing PDL data and print job processing instructions for a print job including at least one page before raster image processing of the print job by a raster image processor associated with a printer, the method further including at least one of:
removing overprint commands from the print job;
converting all objects on the at least one page into a common colorspace; and
removing embedded tone reproduction curves and halftone screens from the print job.

2. The method of claim 1, wherein the print job is defined in a Page Description Language (PDL) as a PDL file.

3. The method of claim 1, wherein said page description language (PDL) instructions executable by a raster image processor (RIP) associated with a printer.

4. The method of claim 1 wherein said common color space comprises a user specified industry standard.

5. The method of claim 1 wherein said common color space comprises a user defined colorspace.

6. The method of claim 1 wherein said common color space comprises a system generated color space.

7. The method of claim 1 wherein said method is executed by a digital front end in said printer.

8. The method of claim 1, wherein said method is specified remotely over a data network to the system's interface at the time of a document's submission to the system.

9. A method for improving color consistency of prints by preprocessing PDL data and print job processing instructions for a print job including at least one page before sending the print job to a raster image processor associated with a printer, the method further including at least one of:
flattening all objects on the at least one page into a single layer;
converting all objects on the at least one page into a common colorspace; and
removing embedded tone reproduction curves and halftone screens from the print job.

10. The method of claim 9, wherein the step of flattening all object on the at least one page into a single layer resolves transparent objects and overprint objects in the print job.

11. The method of claim 9, wherein the print job is defined in a Page Description Language (PDL) as a PDL file including said print job instructions.

12. The method of claim 11, wherein said instructions are executable by the raster image processor (RIP) associated with a printer.

13. The method of claim 9 wherein said common color space comprises a user specified industry standard.

14. The method of claim 9 wherein said common color space comprises a user defined colorspace.

15. The method of claim 9 wherein said common color space comprises a system generated color space.

16. The method of claim 9 wherein said method is executed by a digital front end in said printer.

17. The method of claim 9, wherein said method is specified remotely over a data network to the system's interface at the time of a document's submission to the system.

18. A color printing system adapted for improving color consistency of prints, comprising:
a data processing system;
a color consistency module executed by said data processing system to implement color consistency as a single user control to obtain improved documents from the printing system, wherein said color consistency module and data processing system interpret and execute printing instructions and a page description language associated with a print job comprising of at least one page that enable the data processing system to execute at least one of:
flattening all objects on the at least one page into a single layer;
removing overprint commands from the print job;
converting all objects on the at least one page into a common colorspace;
removing embedded tone reproduction curves and halftone screens from the print job.

19. The color printing system of claim 18 wherein said data processing system further comprises a digital front end associated with said color printing system to interpret and execute said instructions.

20. The color printing system of claim 18 wherein said data processing system further comprises an input output terminal associated with said color printing system to interpret and execute said instructions.
